(19) United States
(12) Patent Application Publication
(10) Pub. No.: US 2016/0017963 A1
(43) Pub. Date: Jan. 21, 2016

(54) TENSIONING DEVICE FOR A TRACTION MEMBER

(71) Applicants: Dirk ALBRECHT, Eschweiler (DE); Nicolas TRONQUOY, Fondettes (FR)

(72) Inventors: Dirk ALBRECHT, Eschweiler (DE); Nicolas TRONQUOY, Fondettes (FR)

(73) Assignee: Aktiebolaget SKF, Goteberg (SE)

(21) Appl. No.: 14/801,078

(22) Filed: Jul. 16, 2015

(30) Foreign Application Priority Data
Jul. 18, 2014 (FR) 1456952

(51) Int. Cl. F16H 7/10

(52) U.S. Cl. CPC F16H 7/10; F16H 2007/081

(57) ABSTRACT

A tensioning device for a traction member, such as a belt, for an internal combustion engine, the tension device comprising a pulley rotatably mounted on an eccentric hub also rotatably mounted on a shaft. One end of the shaft comprises a shoulder against which abuts a plate for attaching the device onto the internal combustion engine. The tensioning device further comprises a torsions spring mounted around a tubular portion of the hub extending along a longitudinal direction of the hub between the hub and the attachment plate. The tensioning device also comprising a spring holder interposed between the spring and the attachment plate. An end turn of the spring is attached around an axial portion of the spring holder.

### CROSS REFERENCE TO RELATED APPLICATIONS

This is a Non-Provisional Patent Application, filed under the Paris Convention, claiming the benefit of French Patent (FR) Application Number 1456952, filed on 18 Jul. 2014, which is incorporated herein by reference in its entirety.

### TECHNICAL FIELD

The invention relates to a tensioning device for a traction member such as a belt.

### BACKGROUND ART

Internal combustion engines, notably in the field of automotive manufacturing, are often equipped with traction members such as belts for driving into rotation certain pieces of equipment. Such traction members have to be continuously maintained tensioned by tensioning devices.

US-A-2010/0113199 describes a tensioning device comprising a pulley rotatably mounted on an eccentric hub itself also rotatably mounted on a shaft on which is mounted a plate for attaching the device on an internal combustion engine. This device further comprises a torsion spring allowing tensioning of the traction member. The spring is mounted in a support interposed between the spring and the attachment plate.

The support is only centered by its positioning on the attachment plate. Further, the spring is not in radial contact with the support which therefore requires a relatively substantial axial length for guiding the spring. The axial compactness of the device is therefore thereby reduced.

These are the drawbacks which the invention intends to remedy by proposing a novel tensioning device for a traction member, for which the structure of the spring holders allows better axial compactness.

### BRIEF SUMMARY OF THE PRESENT INVENTION

For this purpose, the invention relates to a tensioning device for a traction member, such as a belt, for an internal combustion engine, comprising a pulley rotatably mounted on an eccentric hub also rotatably mounted on a shaft, one end of which comprises a shoulder against which abuts a plate for attaching the device on the internal combustion engine, this device further comprising a torsion spring mounted around a tubular portion of the hub extending along a longitudinal direction of the hub between the hub and the attachment plate, the device also comprising a spring holder interposed between the hub and the attachment plate. This device is characterized in that an end turn of the spring is attached around an axial portion of the spring holder.

By means of the invention, the spring is axially and radially blocked by its support. The support length required for guiding the spring is therefore reduced. The tensioning device therefore has better axial compactness as compared with the tensioning devices of the state of the art.

According to advantageous but non-mandatory aspects of the invention, such a tensioning device may incorporate one or several of the following features, taken in any technically acceptable combination:
The spring holder comprises a radial portion which extends in the direction of the shaft.
The radial portion of the spring holder is in contact with the shaft.
The spring holder comprises a tubular portion parallel to a longitudinal direction of the hub and in which extends radially between the tubular portion of the hub and the spring.
The tubular portion of the spring holder covers an end of the tubular portion of the hub.
The tubular portion of the spring holder is in radial contact with the tubular portion of the hub.
The internal bore of at least the first turn of the spring attached around the central axial portion of the spring holder has an inner diameter of less than the outer diameter of said axial portion when the spring holder is in a free non-mounted condition.

### BRIEF DESCRIPTION OF THE DRAWINGS

The invention will be better understood and other advantages thereof will become more clearly apparent upon reading the description which follows, only given as a non-limiting example and made with reference to the appended drawings wherein:

FIG. 1 is a partial sectional view of a tensioning device according to a first embodiment of the invention; and

FIG. 2 is a similar sectional view to FIG. 1, of a tensioning device according to a second embodiment of the invention.

### DETAILED DESCRIPTION OF THE PRESENT INVENTION

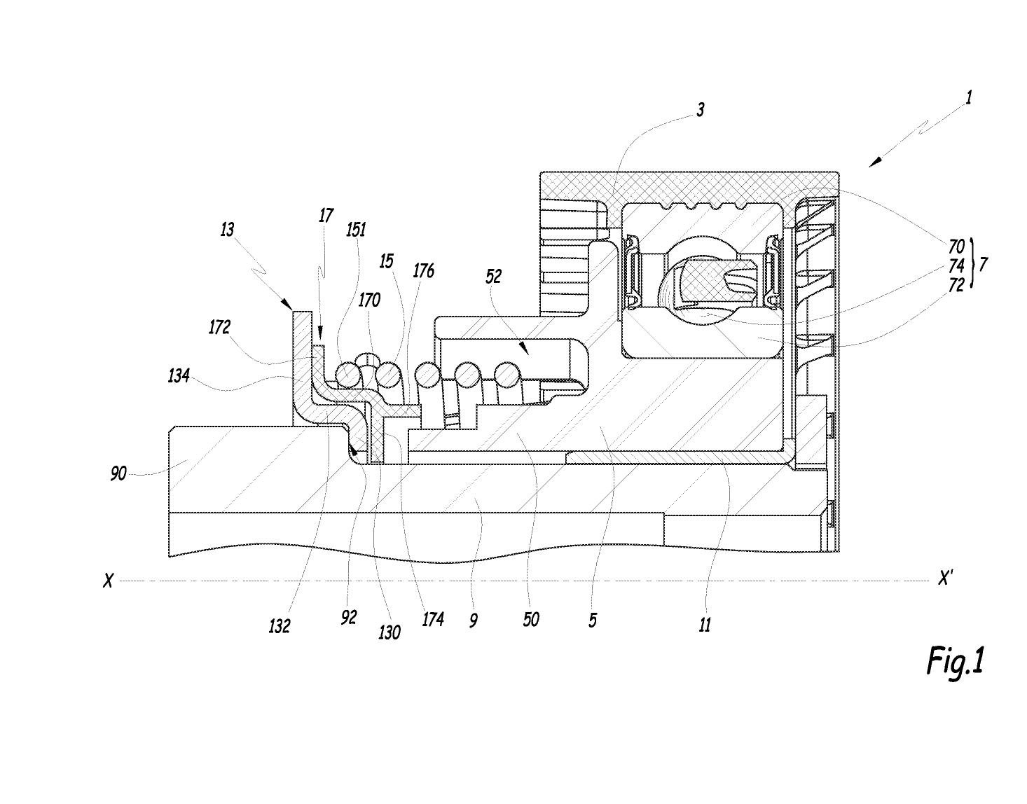

FIG. 1 represents a tensioning device 1 for a traction member not shown, such as a belt, or for an internal combustion engine also not shown. The tensioning device 1 comprises a pulley 3 rotatably mounted on an eccentric hub 5. The rotation of the pulley 3 or relatively to the hub 5 is made possible by a ball bearing 7, comprising an outer ring 70 rotatably secured to the pulley 3, an inner ring 72, rotatably secured to the hub, and balls 74 interposed between the inner ring 72 and the outer ring 70. Alternatively, not shown, the roller bearing 7 may comprise different rolling elements from the balls 74, such as rollers or needles.

The hub 5 is itself rotatably mounted on a shaft 9. Rotation between the hub 5 and the shaft 9 is allowed by a bearing 11.

The tensioning device 1 is arranged around a longitudinal direction X-X′. The rotations of the hub 5 relatively to the shaft 9 and of the roller 3 relatively to the hub 5 take place around axes not shown parallel to the longitudinal direction X-X′.

The shaft 9 comprises, at an opposite end 90 relatively to the pulley 3, a shoulder 92 against which abuts a plate 13 for attaching the tensioning device 1 onto the internal combustion engine. The attachment plate 13 comprises an internal radial portion 130 which abuts against the shoulder 92. The internal radial portion 130 extends towards the end 90 through an axial portion 132 which surrounds the shaft 9 and ensures centering of the plate 13 relatively to the shaft 9. Finally, the plate 13 comprises an external radial portion 134.

The tensioning device 1 further comprises a torsion spring 15 mounted around a tubular portion 50 of the hub 5 extending, along the longitudinal direction X-X′, between the hub 5 and the attachment plate 13. The hub 5 forms a ring-shaped housing 52, in which the spring 15 is mounted, and which extends around the tubular portion 50.

The tensioning device 1 also comprises a spring holder 17 interposed, along the direction X-X′, between the spring 15 and the attachment plate 13. The spring 15 is tensioned between the hub 5 and the support 17 and generates a tensional force on the belt which rests on the pulley 3. The operation of such a device is well known to one skilled in the art and will not be more extensively described hereafter.

The spring holder 17 allows centering and longitudinal guidance of the spring 15. The spring holder 17 for this purpose comprises a central axial portion 170 which surrounds the axial portion 132 and which allows centering of the spring holder 17 relatively to the plate 13. An end turn 151 of the spring 15 is fixedly mounted around the axial portion 170, so that this turn 151 is axially and radially blocked on the spring holder 17. The axial length of the support 17 is therefore relatively small, which guarantees good axial compactness of the tensioning device 1.

The axial portion 170 extends through an external radial portion 172 which abuts against the external radial portion 134.

On the side of the hub 5, the spring holder 17 comprises an internal radial portion 174 which extends the axial portion 170 towards the shaft 9. The radial portion 174 extends as far as the shaft 9, so that the support 17 bears against the shaft 9 or a small play exists between the radial portion 174 and the shaft 9. This gives the possibility of directly ensuring centering of the support 17 relatively to the shaft 9 and not via the plate 13. Further, this feature improves the seal of the device 1 by a labyrinth system.

The spring holder 17 also includes a tubular portion 176, perpendicular to the internal radial portion 174 and to the longitudinal direction X-X′ and which radially extends between the tubular portion 50 of the hub 5 and the spring 15.

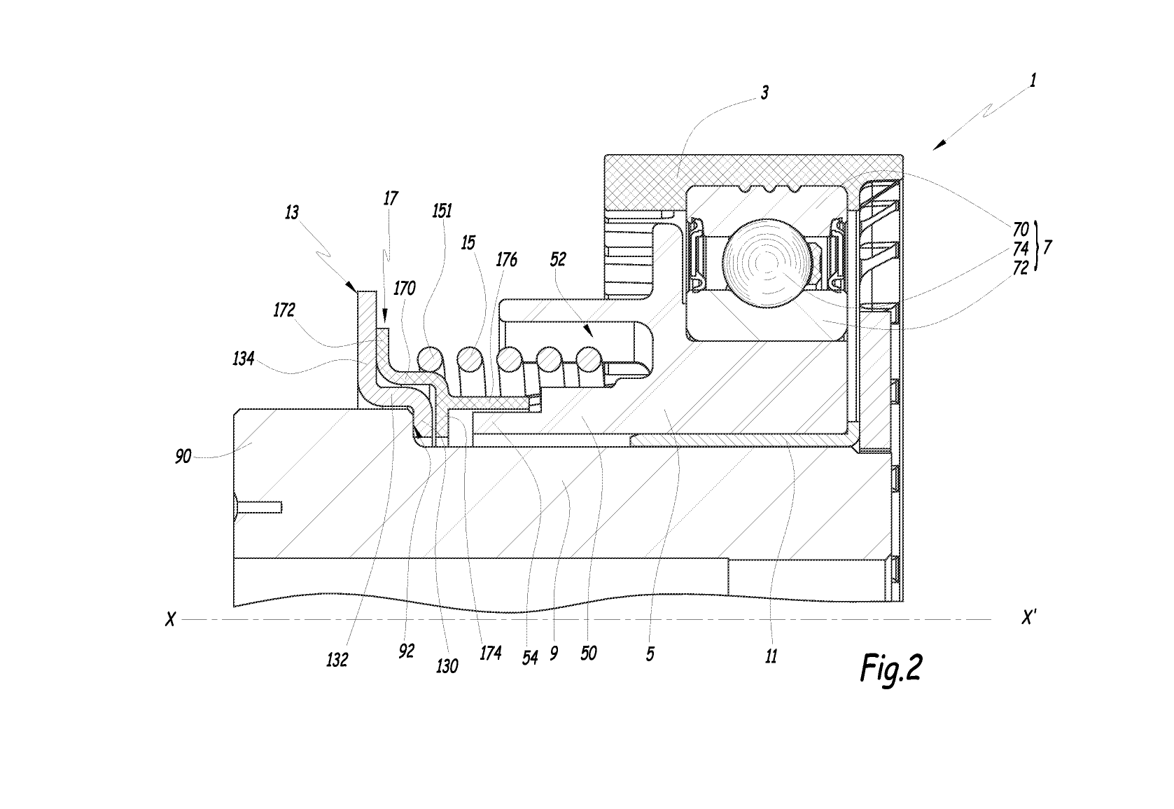

A second embodiment of the invention is illustrated in FIG. 2. In this embodiment, the elements similar to those of the first embodiment bear the same references and operate in the same way. Only the differences relative to the first embodiment are detailed hereafter.

In this embodiment, the tubular portion 176 covers an end 54 of the hub 5, which extends the tubular portion 50 along the longitudinal direction X-X′ on the side of the attachment plate 13. The tubular portion 176 may be in contact with the end 54, or else a small radial play may exists between the tubular portion 176 and the end 54. The spring holder 17 is thus directly centered relatively to the hub 5. In this case, the internal radial portion 174 may not extend as far as the shaft 9.

More specifically, the internal bore of at least the first turn 151 has an inner diameter substantially less than the outer diameter of said axial portion 170, when the spring holder 17 is in a free non-mounted condition, i.e. when the spring 15 is not mounted on the support 17, so that at least this first turn 151 of the spring 15 will come into direct contact with the central portion 170. The diameters being thus dimensioned, when the spring holder 17 is mounted, the spring 15 exerts a radial force towards the inside of the device 1, inducing a radial deformation of the central portion 170 of the spring holder 17. The tubular portion 176 of the spring holder 17, which axially extends from the central portion 170, is found radially shifted towards the inside of the device. In particular, the tubular portion 176 is found in close proximity or even in direct contact with the end 54 of the hub 50.

This arrangement provides an increased seal of the device 1, between the tubular portion 176 and the hub 50. Further, this ensures a minimum length of the axial guidance of the spring 15, allowing de facto reduction in the axial dimensions of the device 1.

The features of the embodiments and alternatives described above may be combined in order to form novel embodiments of the invention.

1. A tensioning device for a traction member, such as a belt, for an internal combustion engine, the tensioning device comprising:
a pulley rotatably mounted on an eccentric hub also rotatably mounted on a shaft, wherein an end of the shaft comprises a shoulder against which abuts a plate for attaching the device onto an internal combustion engine;
a torsion spring mounted around a tubular portion of the hub extending along a longitudinal direction of the hub between the hub and the attachment plate; and
a spring holder interposed between the spring and the attachment plate,
wherein an end turn of the spring is attached around an axial portion of the spring holder.

2. The tensioning device according to claim 1, the spring holder further comprising a radial portion, which extends towards the shaft.

3. The tensioning device according to claim 2, wherein the radial portion of the spring holder is in contact with the shaft.

4. The tensioning device according to claim 1, the spring holder further comprising a tubular portion parallel to a longitudinal direction of the hub and which extends radially between the tubular portion of the hub and the spring.

5. The tensioning device according to claim 4, wherein the tubular portion of the spring holder covers an end of the tubular portion of the hub.

6. The tensioning device according to claim 5, wherein the tubular portion of the spring holder is in radial contact with the tubular portion of the hub.

7. The tensioning device according to claim 1, wherein the internal bore of at least the end turn of the spring attached around the central axial portion of the spring holder has an inner diameter of less than an outer diameter of said axial portion, when the spring holder is in a free non-mounted condition.
